(19) United States
(12) Patent Application Publication
(10) Pub. No.: US 2006/0260657 A1
(43) Pub. Date: Nov. 23, 2006

(54) System and apparatus for supplying carbon dioxide to a semiconductor application

(76) Inventors: Richard John Jibb, Amherst, NY (US); Richard Martin Kelly, Buffalo, NY (US); John Fredric Billingham, Getzville, NY (US); Thomas John Bergman JR., Clarence Center, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/131,220

(22) Filed: May 18, 2005

(51) Int. Cl. B08B 3/02

(52) U.S. Cl. 134/94.1; 134/95.1; 134/105; 134/108

(57) ABSTRACT

A system and apparatus for the delivery of a high purity carbon dioxide fluid is provided. The system includes at least two separate semiconductor applications, wherein one of said applications requires refrigeration. A first portion of the carbon dioxide stream is drawn off the supply line and directing it to a first semiconductor application. A second portion is drawn off the supply line and routed to a second semiconductor application across a pressure-reduction device thereby reducing the temperature and pressure of the second gas, entering the second semiconductor application.

### BACKGROUND OF THE INVENTION

1. Field of the Invention

The present invention relates to a system and apparatus that uses carbon dioxide fluid in a semiconductor application requiring refrigeration.

2. Description of Related Art

Manufacture of semiconductor devices involves a number of discrete steps in which multiple applications perform processes to construct an integrated circuit. Some of these processes include thin film deposition, photolithographic pattern development, plasma etching, metal deposition, ion implantation, thermal oxidation/annealing, chemical-mechanical polishing/planarization, etc.

Between some of these discrete process steps, a semiconductor device may be cleaned to remove contaminants and residues. Most conventional semiconductor cleaning applications perform processes using organic, inorganic and aqueous liquid chemical solutions. Unfortunately, these chemicals do not adequately remove some contaminants and residues from the semiconductor devices. Additionally, some liquid chemical solutions may possess physical properties that are deleterious to semiconductor devices. Properties of the liquid chemical solutions such as surface tension can create capillary effects in nano-featured devices which may lead to image collapse. Furthermore, conventional cleaning application processes often require additional process steps to dry the wafer and remove residual moisture.

Semiconductor cleaning applications using supercritical carbon dioxide with or without chemical additives have been developed to overcome the deleterious effects of the conventional cleaning application processes. The term “supercritical” as utilized herein will be understood by those skilled in the art as referring to a fluid that is above its critical temperature and pressure (e.g., approximately 31° C. and 1067 psia, respectively, for carbon dioxide). Supercritical carbon dioxide supply and recycle systems which distribute high-pressure carbon dioxide throughout a semiconductor manufacturing facility have also been developed in support of these new semiconductor cleaning applications.

Other semiconductor applications such as plasma etching, thermal oxidation/annealing, liquid/vapor waste exhaust separation, and others often require a refrigeration utility to maintain low process temperatures. Presently, refrigeration is supplied to these semiconductor applications using locally available refrigeration utilities. Common refrigeration utilities include water-based cooling systems which supply and receive the coolant back from the semiconductor application at temperatures shown in the table below.

TABLE

| | Nominal Supply | Nominal Return |
|---|---|---|
| Coolant Type | Temperature (° F.) | Temperature (° F.) |
| Chiller Water | 42 | 56 |
| Glycol-Chilled Water | 32 | <56 |
| Cooling Tower Water | 75 | 90 |
| Tertiary-Chilled Water | 56 | 65 |
| Process Cooling Water | 65 | 70 |

A key disadvantage related to the use of water-based cooling systems is the difficulty of reaching process temperatures below 32° F., which is the freezing point of pure water at atmospheric pressure. Other disadvantages associated with water-based cooling systems include contamination concerns, and high costs associated with water treatment equipment. Coolant temperatures less than 32° F. can reduce the cycle time associated with some semiconductor applications by increasing process temperature cooling rates. Other semiconductor applications such as vapor/liquid waste exhaust separation systems operate more efficiently at temperatures below 32° F.

Other means of providing refrigeration utilities to semiconductor applications include the use of mechanical vapor compression systems. These systems include a compressor, an evaporator, a condenser and a refrigerant storage vessel. U.S. Pat. No. 6,085,544 to Sonnekalb et al describes a carbon dioxide based mechanical refrigeration system in which the carbon dioxide is maintained at a density between 50 percent and 100 percent of the critical density. Such vapor compression refrigeration systems tend to be expensive to install and adapt to a semiconductor applications. In addition, these systems are limited as they require a significant amount of time to respond to process condition changes.

U.S. Pat. No. 5,660,047 to Paganessi discloses the use of a primary liquid refrigerant to cool a secondary liquid refrigerant which is in turn, used to cool a piece of equipment in a semiconductor application. The primary refrigerant liquid is delivered to a pressure vessel containing a heat exchanger. The refrigerant is sprayed onto a first heat exchanger where it is evaporated to cool the secondary liquid refrigerant. The primary refrigerant vapor resulting from evaporation of the primary refrigerant is sent to a second heat exchanger where it is used to pre-cool the secondary liquid refrigerant before the secondary liquid refrigerant is fed to the first heat exchanger. The secondary liquid refrigerant is then delivered to the semiconductor application where it is cycled through a piece of equipment to cool it. A disadvantage associated with the described system is that the primary liquid refrigerant must be delivered to the heat exchanger at low temperature. Therefore, the primary refrigerant source must be located near the semiconductor application in the semiconductor manufacturing facility to minimize heat infiltration into the fluid. However, the high cost associated with space utilization in a semiconductor manufacturing facility can be prohibitive for installing fluid storage systems near a semiconductor application. Alternatively, the primary refrigerant liquid may be delivered from a source external to the semiconductor manufacturing facility. However, the costs associated with effectively insulating the conveyance piping from the primary refrigerant source to the heat exchanger increase dramatically in relation to the distance between the refrigerant source and the heat exchanger.

Japanese Patent Document No. 2002-204942 to Katsumi et al describes a process for extracting a contaminant from a liquid stream in which the liquid stream is injected into the refrigeration system compressor. The compressor discharge pressure meets or exceeds the critical pressure of carbon dioxide. The mixture is then throttled to low pressure, generating refrigeration and forms a two-phase mixture. This two-phase mixture is separated in a phase separation apparatus, and the resulting carbon dioxide vapor/contaminant stream is recycled to the compressor, while the contaminant-free liquid stream is collected. A disadvantage associated with the system described is that the carbon dioxide leaving the phase separation apparatus contains the contaminant and therefore cannot be used in additional applications.

The related art also describes semiconductor-cleaning processes that employ low-temperature carbon dioxide as a cleaning medium. For example, U.S. Patent Application Publication No. 2003/0119424 Al to Ahmadi et al describes a snow cleaning process in which high pressure carbon dioxide is throttled to low pressure across an injection nozzle, generating a low temperature solid/vapor mixture. The two-phase mixture is targeted at a semiconductor or other device such that solid carbon dioxide particles impinge on the surface of the semiconductor device. Momentum transfer from the solid carbon dioxide particles promotes the separation of surface contamination from the semiconductor or other device. Additionally, the semiconductor or other device is heated to promote vaporization of the solid carbon dioxide particles contacting the surface of the device. Thermophoresis due to the warm surface of the semiconductor or other device and the cold vaporized gas promotes the separation of remaining contaminants from the device surface.

U.S. Pat. No. 6,612,317 to Costantini et al and U.S. Patent Application Publication No. 2003/0051741 to DeSimone et al describes carbon dioxide based semiconductor wafer cleaning applications. Liquid carbon dioxide leaving the semiconductor wafer cleaning application is directed to a lower pressure waste collection vessel. The resulting pressure drop creates a lower temperature stream which is collected in the lower pressure waste collection vessel.

A disadvantage associated with the related-art carbon dioxide based semiconductor cleaning applications is that they do not generate refrigeration in a constant and controlled manner. These cleaning applications operate in a batch manner in which individual devices are processed separately.

The process begins by inserting a semiconductor device into a pressure chamber. The chamber is initially pressurized with carbon dioxide. Additional solvents and chemicals are injected into the high-pressure carbon dioxide to create a carbon dioxide based cleaning solution. The carbon dioxide based cleaning solution is circulated through the pressure chamber to promote contamination removal from the semiconductor device. Following recirculation, carbon dioxide may be fed through the pressure chamber and directly exhausted to purge the cleaning solution. Additional chemical injections, recirculations, and purges are repeated as necessary to achieve the desired level of contamination removal. When the cleaning process is complete, the pressure chamber is depressurized to atmospheric pressure by exhausting all of the carbon dioxide from the cleaning application and the semiconductor device is removed.

During the purge step of the cleaning process, the pressure of the cleaning solution is significantly reduced as it is exhausted from the cleaning application. The Joule-Thompson effect associated with the high differential pressure generates a lower pressure and temperature exhaust stream. Typically, the pressure differential across the cleaning application exhaust valve is maintained for a period of time until the purge step is complete. The depressurization step also creates a lower pressure and temperature exhaust stream however, as the internal pressure of the cleaning application decreases the pressure differential is reduced and the exhaust stream temperature rises. Once the cleaning application reaches atmospheric pressure, exhaust flow ceases and the cleaned semiconductor device is removed from the cleaning application.

The low temperature exhaust stream generated by the cleaning application as described is highly intermittent and variable depending upon the parameters of the cleaning application process. Therefore the exhaust from a semiconductor cleaning application cannot provide a continuous steady-state refrigeration source. Moreover, the related art does not recognize the use of the low temperature exhaust stream generated by the cleaning application as a refrigerant for delivery to a separate semiconductor application.

To overcome the disadvantages of the related art, it is an object of this invention to provide a system where a first portion of a carbon dioxide stream is delivered to a semiconductor application and a second portion of said carbon dioxide stream is delivered to a semiconductor application requiring refrigeration.

It is another object of this invention to deliver the second portion to a semiconductor application requiring refrigeration in a controlled and continuous manner.

It is a further object of this invention to reduce capital expenditure on refrigeration generation systems for semiconductor applications by using a single carbon dioxide processing system for both cleaning and refrigeration applications.

Other objects and advantages of the invention will become apparent to one skilled in the art on a review of the specification, figures and claims appended hereto.

### SUMMARY OF THE INVENTION

The foregoing objectives are met by the system and apparatus of the present invention.

According to a first aspect of the invention, a system is provided for supplying a carbon dioxide fluid to at least two separate semiconductor applications, wherein one of said applications requires refrigeration. The system includes: (a) utilizing a pre-treatment means to pre-treat a fluid including a carbon dioxide component to form a pre-treated carbon dioxide stream; (b) directing via a first conduit a first portion of the pre-treated carbon dioxide stream to a first semiconductor application, wherein the first portion is converted to a first effluent stream; (c) directing via a second conduit a second portion of the pre-treated carbon dioxide stream across a pressure-reduction device, forming a lower pressure and temperature second stream; and (d) routing the lower pressure and temperature second stream exiting the pressure-reduction device to a second semiconductor application, wherein the low pressure and temperature second stream is used as a cooling utility within the second semiconductor application, and then converted to a second effluent stream.

According to another aspect of the invention, an apparatus is provided for supplying a carbon dioxide fluid to at least two separate semiconductor applications, wherein one of said applications requires refrigeration. The system includes: (a) utilizing a pre-treatment means to pre-treat a fluid including a carbon dioxide component to form a pre-treated carbon dioxide stream; (b) directing via a first conduit a first portion of the pre-treated carbon dioxide stream to a first semiconductor application, wherein the first portion is converted to a first effluent stream; (c) directing via a second conduit a second portion of the pre-treated carbon dioxide stream across a pressure-reduction device, forming a lower pressure and temperature second stream; and (d) routing the lower pressure and temperature second stream exiting the pressure-reduction device to a second semiconductor application, wherein the low pressure and temperature second stream is used as a cooling utility within the second semiconductor application, and then converted to a second effluent stream.

### BRIEF DESCRIPTION OF THE FIGURES

The invention will be better understood by reference to the figures wherein like numbers denote same features throughout and wherein:

FIG. 1 illustrates a schematic diagram of a delivery system for a fluid containing a carbon dioxide component to at least two semiconductor applications disposed in parallel;

FIG. 2 illustrates a sectional view of the semiconductor application discarding the effluent generated therein to waste;

FIG. 3 illustrates a schematic diagram of an alternate recycling system for the effluent exiting the refrigeration consuming semiconductor applications;

FIG. 4 illustrates a schematic diagram of an embodiment of an alternate recycling system for the effluent exiting the refrigeration consuming semiconductor applications where the effluent is recycled directly to a pressurization means within a pre-treatment means;

FIG. 5 illustrates a schematic diagram of an embodiment of an alternate recycling system for the effluent exiting the semiconductor cleaning applications where the effluent is recycled directly to a purification means within a pre-treatment means, and the effluent exiting the refrigeration consuming semiconductor applications is recycled directly to a pressurization means within a pre-treatment means.

FIG. 6 is a schematic diagram of yet another embodiment, where the effluent exiting the first semiconductor application is routed to a separator and a heat exchange device; and

FIG. 7 illustrates a schematic diagram of an example refrigeration circuit where a carbon dioxide stream is used to cool a secondary fluid refrigerant provided to a semiconductor application.

### DETAILED DESCRIPTION OF THE INVENTION

The manufacturing of integrated circuits requires many discrete processing steps, where cooling or refrigeration of a semiconductor application is necessary. The invention provides an efficient and effective manner of utilizing a carbon dioxide stream in a processing step and diverting part of the same initial stream to a second semiconductor application where a different processing step is carried out. A refrigerant is generated from the diverted stream and employed to provide a cooling utility stream to the second semiconductor application.

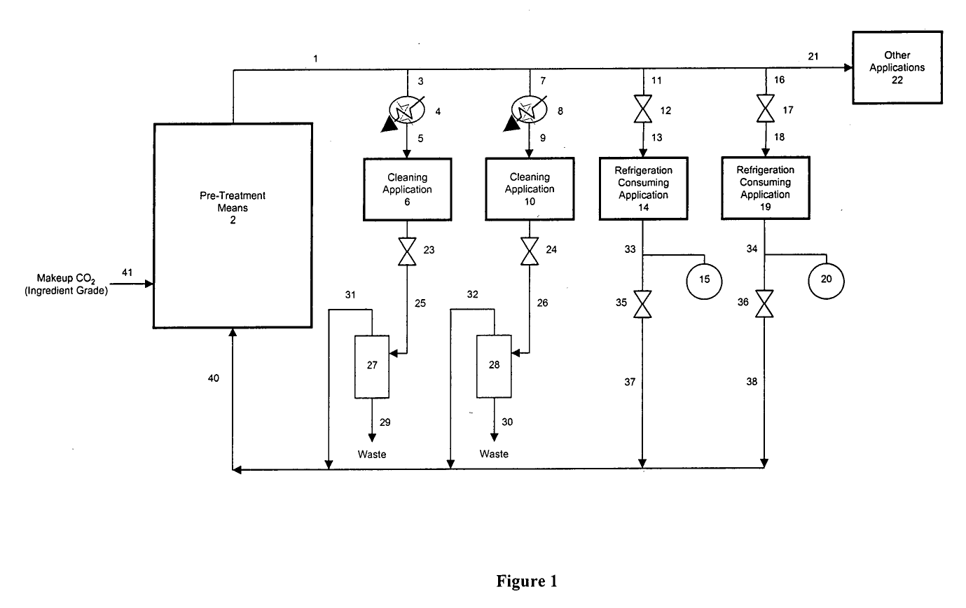

With reference to FIG. 1, one of the embodiments of the invention is described. A commercial grade fluid including a carbon dioxide component is supplied to a pre-treatment means 2 where the fluid may be pre-treated to an ultra-pure form. As utilized herein, the term “ultra-pure” refers to a purity of at least 99.99995 percent or higher, which is suitable for semiconductor manufacturing. The pre-treated carbon dioxide fluid is conveyed via conduit 1 at a high pressure to semiconductor applications 6, 10, 14 and 19. The pressure associated with the stream removed from pre-treatment means 2 typically ranges from about 600 to 4000 psig, preferably about 800 psig to 3500 psig, and most preferably about 1000 psig to 3200 psig. The temperature of the stream ranges from about 50° F. to 90° F.

The pre-treated carbon dioxide stream in conduit 1 can be separated in a number of stream portions, where a first portion is directed through a first pre-heater 4 disposed on conduit 3. The pre-heater increases the temperature to a range from about 60° F. to 300° F., preferably about 70° F. to 200° F., and most preferably to about 80° F. to 150° F. The high temperature pre-treated carbon dioxide stream is further conveyed via conduit 5 to a first semiconductor application 6, where the particular process is conducted, and a first effluent is generated. First semiconductor application 6 is preferably a batch cleaning application.

The first effluent stream typically contains a carbon dioxide component and a contaminant component. The contaminant component may consist of additives injected into the first pre-treated carbon dioxide stream for the purpose of assisting in the cleaning of a semiconductor device. Additional contaminant components in the first effluent stream may result from the dissolution and entrainment of contaminants contained upon the semiconductor device being cleaned.

The first effluent exits the semiconductor application upon opening of a discharge valve or a multiple of discharge valves 23 and is conveyed via conduit 25 to a waste separation application 27, where a carbon dioxide enriched vapor stream and a contaminant enriched liquid/solid stream are generated. The use of a waste separation application is desirable to remove and collect a larger portion of the contaminants entrained in the cleaning application effluent for disposal. Additionally, the concentration of these contaminants is reduced in the carbon dioxide enriched stream leaving the waste separation application. The pressure of the effluent stream is reduced as it passes into the waste separation application, forming a multiple phase mixture consisting of a vapor phase and a liquid/solid phase. The operating pressure of waste separation application 27 dictates the degree of separation into the particular phases (i.e. solid, liquid, and vapor). Typically, the waste separation application 27 operates at pressures ranging from about 0 psig to 1000 psig, preferably about 100 psig to 800 psig, and most preferably about 250 psig to 700 psig. The typical waste separation system operating temperature will range about −215° F. to 100° F., preferably about −55° F. to 70° F., and most preferably −10° F. to 55° F. A carbon dioxide enriched vapor stream is removed from the waste separation application 27 via conduit 31 and recycled via conduit 40 back to pre-treatment means 2. A contaminant enriched liquid/solid stream is also removed from the waste separation application 27 via conduit 29, and directed to waste.

A second portion of the pre-treated carbon dioxide stream may be separated from conduit 1 and directed via a distribution manifold system to a pressure-reducing device 12 disposed on conduit 11. As the second portion of the pre-treated carbon dioxide is throttled across pressure-reducing device 12, a lower-pressure and temperature stream results due to the Joule-Thompson effect. The lower pressure and temperature second stream is conveyed via conduit 13 to semiconductor application 14. Semiconductor application 14 is preferably selected from a group of semiconductor applications that require refrigeration such as plasma etch, thermal annealing/oxidation or waste separation applications. The specific pressure and temperature associated with the resulting stream is determined by the refrigeration temperature desired for the particular semiconductor application. Typically, the pressure associated with the stream fed to the second semiconductor application 14 ranges from about 0 psig to 1000 psig, preferably about 0 psig to 800 psig and most preferably about 0 psig to 650 psig. The temperature of the resulting stream typically ranges from about −110° F. to 70° F., preferably −110° F. to 60° F., most preferably −110° F. to 50° F. A process is carried out in the second application where a portion of the refrigeration is extracted from the lower pressure and temperature stream and a second effluent is generated. The flow and pressure of the stream are manipulated to deliver the required amount of refrigeration to application 14. The effluent exiting second semiconductor application 14 is conveyed via conduit 33 to pressure reducing device 35 where it is throttled to produce a lower pressure stream. The resulting lower pressure stream is conveyed via conduit 37 to conduit 40 where it is mixed with the effluent from other semiconductor applications and recycled to pre-treatment means 2.

In accordance with another embodiment, and as further illustrated in FIG. 1, one or more additional batch cleaning applications may be disposed in parallel. A portion of the pre-treated carbon dioxide stream can be simultaneously directed to the batch cleaning application 6, and a second batch cleaning application 10. The carbon dioxide stream is conveyed through a pre-heater 8 disposed on conduit 7 and subsequently via conduit 9 to a second batch cleaning application. The carbon dioxide stream delivered to the second batch cleaning application 10 will typically be at the same or similar conditions as the stream delivered to the first batch cleaning application 6. Thereafter, an effluent stream is routed through exhaust valve 24 via conduit 26 to a waste separation application 28, which is operated in the same or similar manner and under the same or similar conditions as waste separation application 27. The carbon dioxide enriched vapor stream removed via conduit 32 from the waste separation application 28 can be mixed with the carbon dioxide enriched vapor stream removed via conduit 31 from waste separation application 27 and recycled back to pre-treatment means 2 via conduit 40.

Similarly, one or more additional refrigeration consuming semiconductor applications can be disposed in parallel to semiconductor application 14 as shown in FIG. 1. For instance, refrigeration consuming semiconductor application 19 is disposed in parallel to semiconductor application 14. In this embodiment, a portion of the pre-treated carbon dioxide fluid in conduit 1 is routed to semiconductor application 19 through a pressure-reducing device 17 disposed on conduit 16. As the pre-treated carbon dioxide is throttled across pressure-reducing device 17, a lower pressure and temperature stream results. The stream is conveyed via conduit 18 to refrigeration consuming semiconductor application 19, and further processed to generate an effluent stream as previously discussed with respect to refrigeration consuming semiconductor application 14. The effluent stream removed from semiconductor application 19, is conveyed via conduit 34 to pressure-reduction device 36 where it is throttled to produce a lower pressure stream. The resulting lower pressure stream is conveyed via conduit 38 to conduit 40 where it is mixed with the effluent streams from other semiconductor applications and recycled to pre-treatment means 2. It will also be recognized by those skilled in the art that conduit 1, may be utilized to deliver pre-treated carbon dioxide fluid to a number of other applications 22, such as a snow cleaning application, which ultimately vents carbon dioxide.

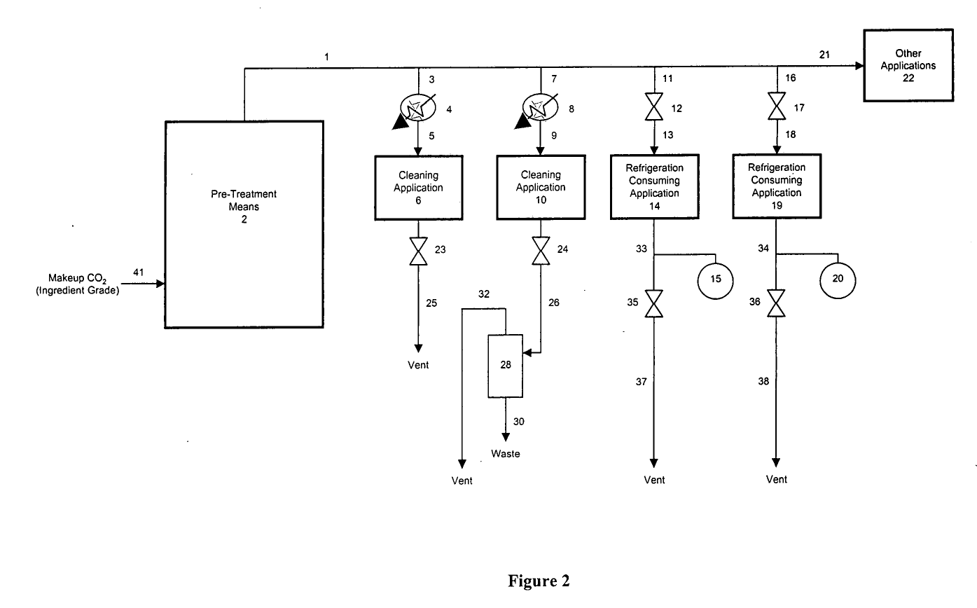

FIG. 2 illustrates an alternative embodiment where the effluent streams exiting various semiconductor applications may be routed to vent and discarded. A first portion of the pre-treated carbon dioxide stream is conveyed to cleaning application 6 and converted to a first effluent as previously described. Said first effluent stream exits cleaning application 6 and is routed through exhaust valve 23 to vent via conduit 25. A second portion of the pre-treated carbon dioxide stream is conveyed to semiconductor application 14 and converted to a second effluent as previously described. Said second effluent stream exits the semiconductor application 14 and is conveyed via conduit 33 through pressure-reduction device 35. The resulting lower pressure stream is routed to vent via conduit 37.

Optionally, the cleaning application effluent stream may be conveyed to a waste separation application and then routed to vent as further illustrated on FIG. 2. A third portion of the pre-treated carbon dioxide stream is conveyed to cleaning application 10 and converted to a third effluent stream as previously described. Said third effluent stream exits cleaning application 10 and is conveyed through exhaust valve 24 to a waste separation application via conduit 26. A larger portion of the contaminants contained within the second effluent are removed in waste separation application 28, generating a carbon dioxide enriched vapor stream 32 which is routed to vent, and a contaminant enriched liquid/solid stream 30 which is directed to waste. In this manner, it will be recognized by those skilled in the art that a waste separation system may be selectively implemented to remove contaminants from the effluent discharged from a semiconductor application.

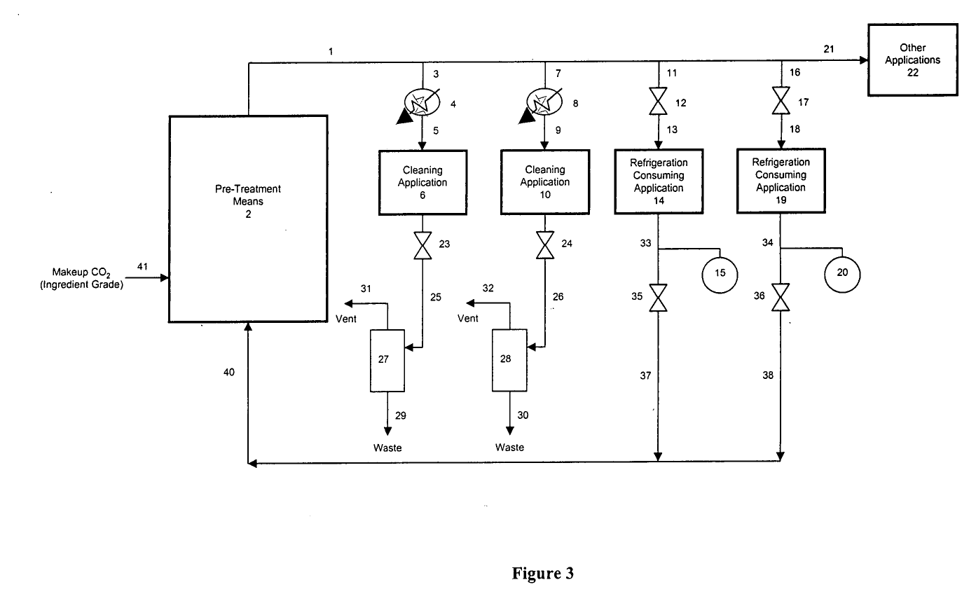

FIG. 3 illustrates another embodiment wherein effluent exiting refrigeration consuming semiconductor applications 14,19, which is not contaminated may be recycled back to the pre-treatment means. However, effluent processed in batch cleaning applications 6,10 contains a portion of carbon dioxide and a portion of contaminants as previously described. The contaminated streams from batch cleaning applications can therefore be routed to vent.

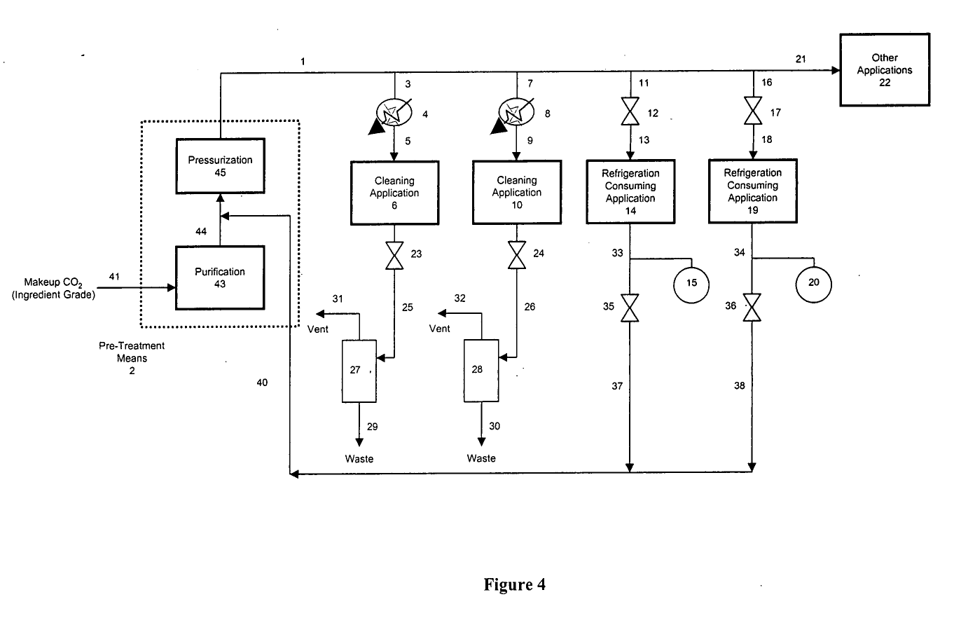

FIG. 4 provides an embodiment wherein a portion of the pre-treatment means 2 may be bypassed if desired. Typically, the pre-treatment means 2 may be separated into a purification unit 43 and a pressurization unit 45. The effluent exiting semiconductor applications 14,19 which is not contaminated, can be routed directly to pressurization unit 45. The effluent, which is essentially pure carbon dioxide is combined with a purified carbon dioxide stream 44 exiting from purification unit 43. The combined stream is conveyed to pressurization unit 45 where it is pressurized and re-distributed to the semiconductor applications via conduit 1. Contaminated effluent exiting batch cleaning applications 6,10 which does not meet the purity requirements of the batch cleaning can be routed to vent via conduits 31,32 and to waste via conduits 29,30.

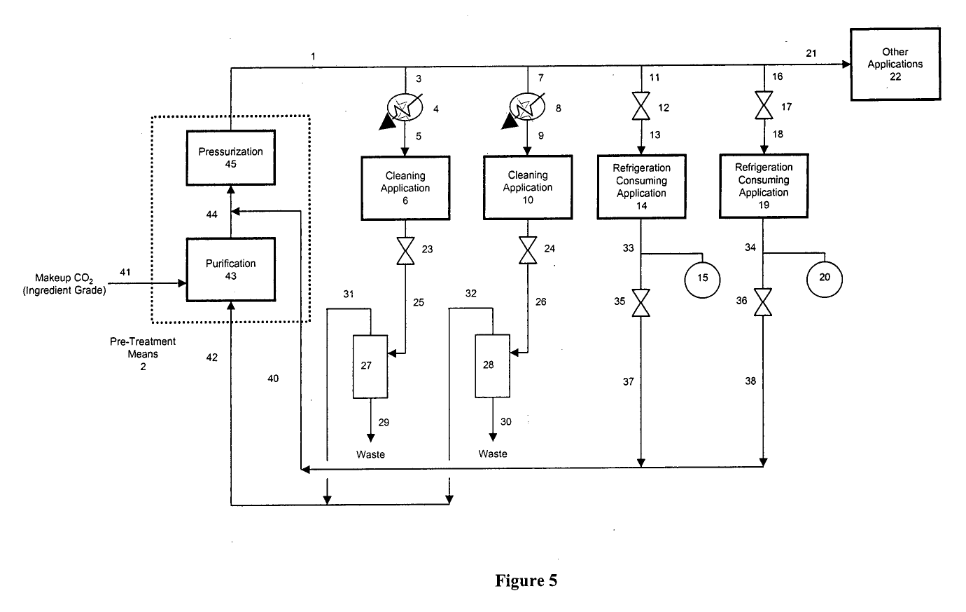

Optionally, FIG. 5 illustrates an arrangement that may be used should it be desirable to direct the contaminated effluent exiting batch cleaning applications 6,10 to purification unit 43 in pre-treatment means 2. The purification unit removes the contaminants contained therein, generating a purified carbon dioxide stream 44. The purified carbon dioxide stream is combined with the essentially pure carbon dioxide effluent stream 40 and conveyed to pressurization means 45. The combined carbon dioxide stream is pressurized and re-distributed to the semiconductor applications via conduit 1.

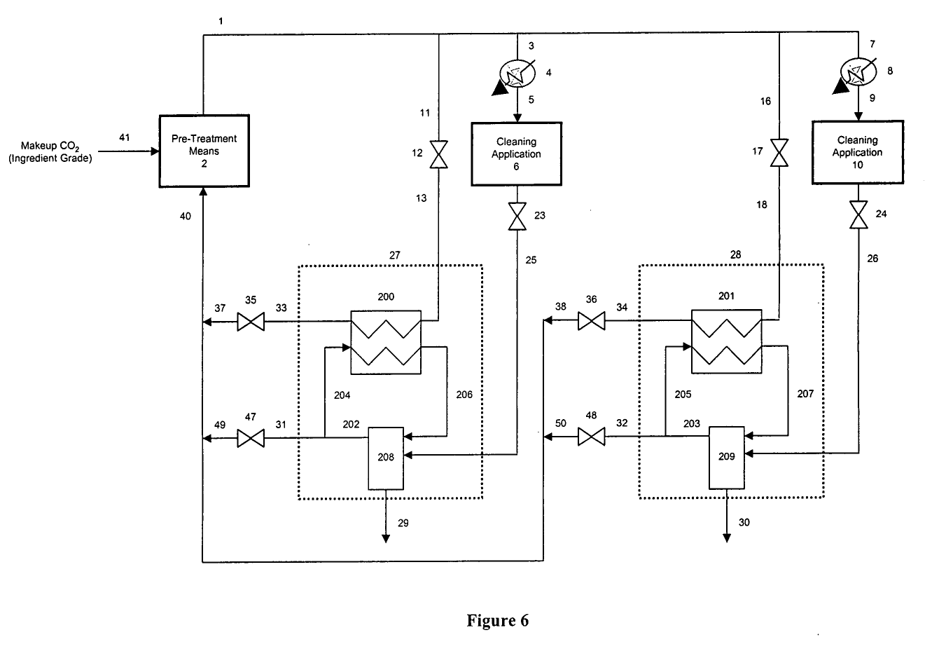

With reference to FIG. 6, another embodiment of the invention is illustrated, and explained with reference to the two batch cleaning applications 6,10 disposed in parallel. The batch cleaning applications are operated in the same manner as previously described, and can be operated independent of one another. In this regard, it will be recognized by those skilled in the art that this explanation is equally applicable to a single or multiple batch cleaning applications and carbon dioxide supply systems.

A first portion of the pre-treated carbon dioxide fluid is conveyed from pre-treatment means 2 via conduit 1 to batch cleaning application 6. The batch cleaning application converts the first pre-treated carbon dioxide stream to a first effluent stream as previously discussed. The effluent is removed from the batch cleaning application through exhaust valve 23 and conveyed via conduit 25 to a waste separation application 27.

A second portion of the pre-treated carbon dioxide fluid routed through conduit 11 and across pressure-reduction device 12. As the pressure of the pre-treated carbon dioxide stream is reduced, a lower pressure and temperature multiple phase mixture is formed which is comprised of a vapor phase and a liquid or solid phase. Typically, the pressure associated with said lower pressure and temperature carbon dioxide stream ranges from about 0 psig to 1000 psig, preferably about 0 psig to 800 psig, and most preferable about 0 psig to 650 psig. The temperature of said stream typically ranges from about −110° F. to 70° F., preferably −110° F. to 60° F., and most preferably −110° F. to 50° F. The lower pressure and temperature carbon dioxide stream is conveyed via conduit 13 to a waste separation application 27. Alternatively, the stream exiting pressure-reduction device 12 can be routed to any semiconductor application which requires refrigeration (i.e., plasma etching, thermal oxidation/annealing) as previously illustrated in FIG. 1.

Upon entering the waste separation application, the first effluent stream 25 from cleaning application 6 is conveyed to a phase separation device 208 where a carbon dioxide enriched vapor stream 202 is separated from a contaminant enriched liquid stream 29. The contaminant enriched liquid stream 29 is routed to waste or optionally an additional waste treatment means. The carbon dioxide enriched vapor stream 202 typically exists at a pressure of about 100 psig to 1000 psig and preferably 200 psig to 800 psig. A first portion of the carbon dioxide enriched vapor stream 202 is routed via conduit 204 to heat exchange device 200 and condensed therein against the multiple phase lower pressure and temperature carbon dioxide stream 13. The lower pressure and temperature carbon dioxide stream 13 typically exists at a temperature of −100° F. to 32° F. The condensed liquid carbon dioxide enriched stream is returned to phase separation device 208 and provides a reflux to aid the separation therein. The second portion of the carbon dioxide enriched vapor stream is removed via conduit 31 and directed across pressure reduction device 47 to form a lower pressure stream 49.

The lower pressure stream 49 is mixed with the effluent from other semiconductor applications and recycled to pre-treatment means 2 via conduit 40. The lower pressure and temperature carbon dioxide stream 13 vaporizes or sublimes in heat exchanger 200 against the condensing carbon dioxide enriched vapor stream 204. The vaporized carbon dioxide stream exits heat exchange device 200 via conduit 33 and is conveyed to a pressure reduction device 35 to form a lower pressure stream 37. The lower pressure stream 37 is mixed with the effluent from other semiconductor applications and recycled back to pre-treatment means 2 via conduit 40.

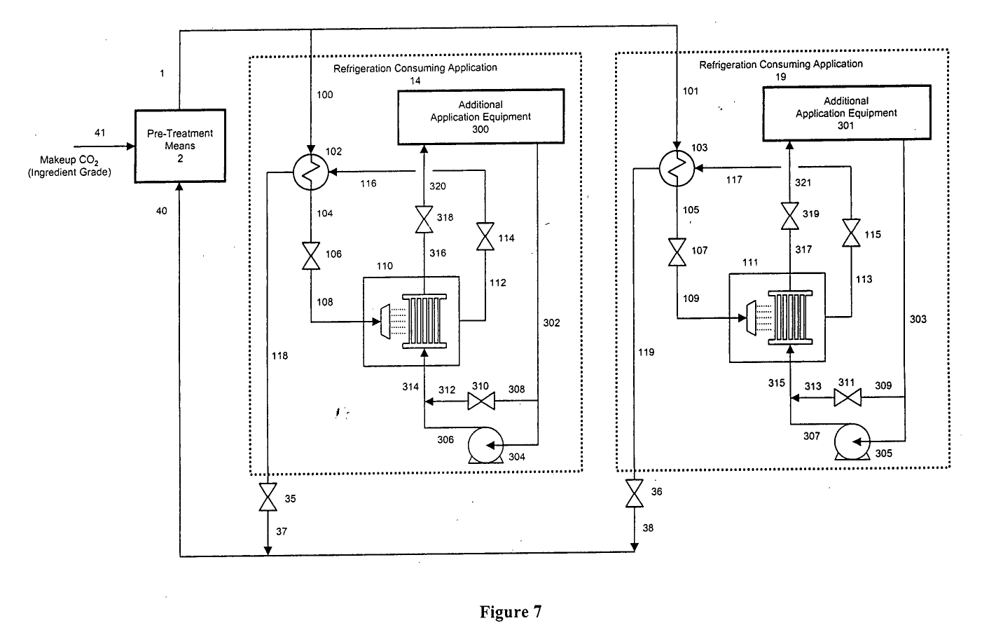

With reference to FIG. 7 another embodiment of the invention is illustrated, and explained with reference to two semiconductor applications 14,19 requiring refrigeration disposed in parallel. It will be obvious to those skilled in the art that the semiconductor applications requiring refrigeration 14,19 may be disposed in parallel to other semiconductor applications which require a carbon dioxide fluid such as a batch cleaning application. An example of a refrigeration circuit is provided where a carbon dioxide stream is used as a primary refrigerant fluid to cool a secondary refrigerant fluid. Carbon dioxide fluid is supplied to a semiconductor application from pre-treatment means 2 and routed via conduit 100 through a heat exchange device 102 for an initial cooling of the carbon dioxide stream against a lower-pressure carbon dioxide stream which is circulated via conduit 116 through heat exchange device 102.

The initially cooled carbon dioxide stream is routed through pressure-reducing device 106 via conduit 104 to generate a lower pressure and temperature stream, as required by the semiconductor tool and which may be a vapor/liquid or vapor/solid mixture. The stream is further conveyed via conduit 108 into a second heat exchange device 110 where it comes into contact, such as by spraying it, against a secondary refrigerant stream which is preferably carbon dioxide and passes therethrough via conduit 314. The lower pressure and temperature carbon dioxide stream delivered via conduit 108 evaporates or sublimes in heat exchanger 110, forming a carbon dioxide vapor stream and transferring its refrigeration to the secondary refrigerant stream. The carbon dioxide vapor stream exits heat exchanger 110 via conduit 112 and is passed through heat exchange device 102 to cool the incoming carbon dioxide stream as previously described. The carbon dioxide vapor stream leaving heat exchange device 102 is conveyed to pressure reduction device 35 via conduit 118. The lower pressure stream is combined with the effluent from other semiconductor applications and recycled to the pre-treatment means via conduit 40.

The secondary refrigerant stream is cooled in heat exchanger 110 as previously discussed. The cooled secondary refrigerant stream is then conveyed via conduit 316 to additional application equipment 300 inside the second semiconductor application requiring refrigeration. The secondary refrigerant is used to cool process temperatures and equipment inside the semiconductor application as exemplified by additional application equipment 300. The used secondary refrigerant is rejected via conduit 302 from the addition application equipment 300 and re-circulated to heat exchanger 110 where it is re-cooled and returned to the additional application equipment.

By way of example, the cooling capacity of the low temperature and pressure stream entering second heat exchanger 110 was calculated. It was determined that approximately 2.4 kW of refrigeration may be generated by expanding 100 lb/hr of carbon dioxide across pressure reduction device 106 at an initial pressure of about 3500 psia to a pressure of about 80 psia. The refrigeration is transferred to the cooling media by vaporizing the lower pressure stream in heat exchanger 110 at a temperature of −55° C. (i.e., 218° K). The amount of refrigeration generated may be increased by 40% to 3.3 kW per 100 lbs/hr of carbon dioxide by introducing a heat exchanger 102 to initially cool the carbon dioxide stream before directing it to the heat exchanger 110.

While the invention has been described in detail with reference to specific embodiments thereof, it will become apparent to one skilled in the art that various changes and modifications can be made, and equivalents employed, without departing from the scope of the appended claims.

What is claimed is:

1. A system for supplying carbon dioxide fluid to at least two separate semiconductor applications, wherein one of said applications requires refrigeration, comprising:
(a) utilizing a pre-treatment means to pre-treat a fluid including a carbon dioxide component to form a pre-treated carbon dioxide stream;
(b) directing via a first conduit a first portion of the pre-treated carbon dioxide stream to a first semiconductor application, wherein the first portion is converted to an effluent stream;
(c) directing via a second conduit a second portion of said pre-treated carbon dioxide stream across a pressure-reduction device, forming a lower pressure and temperature second stream; and
(d) routing said second stream exiting the pressure-reduction device to a second semiconductor application, wherein said second stream is provided as a cooling utility to said second semiconductor application, and the second stream is converted to a second effluent stream.

2. The system for supplying a carbon dioxide fluid according to claim 1, further comprising:
routing the first portion of the pre-treated carbon dioxide stream to a heat exchange device upstream of said first semiconductor application on said first conduit.

3. The system for supplying a carbon dioxide fluid according to claim 1, further comprising:
conveying said first effluent stream to a waste separation device, wherein a carbon dioxide enriched stream is separated from a contaminant enriched stream.

4. The system for supplying a carbon dioxide fluid according to claim 1,
wherein a portion of said first effluent stream is in fluid communication with said pre-treatment means.

5. The system for supplying a carbon dioxide fluid according to claim 3, wherein said second effluent stream generated is mixed with an enriched carbon dioxide stream exiting a waste separation device, and routing the resulting stream to said pre-treatment means.

6. The system for supplying a carbon dioxide fluid according to claim 1, wherein the first semiconductor application is a cleaning application.

7. The system for supplying a carbon dioxide fluid according to claim 1, wherein said second semiconductor application is selected from the group consisting of a plasma etch system, a thermal oxidation/annealing system, or a waste separation system.

8. The system for supplying a carbon dioxide fluid according to claim 1, further comprising:
directing via a second conduit a second portion of said pre-treated carbon dioxide stream across a pressure-reducing device to a heat exchange device disposed upstream of a phase separator disposed in said second semiconductor application.

9. The system for supplying a carbon dioxide fluid according to claim 8, further comprising:
at least partially vaporizing said pre-treated carbon dioxide stream in said heat exchange device to form an at least partially vaporized pre-treated carbon dioxide stream and routing a portion of a carbon dioxide enriched stream exiting a waste separation device to said heat exchange device, wherein said carbon dioxide enriched stream is at least partially condensed to form a partially condensed carbon dioxide enriched stream.

10. The system for supplying a carbon dioxide fluid according to claim 9, further comprising:
returning the partially condensed carbon dioxide enriched stream to said waste separation device whereby a reflux is supplied to said phase separator to further aid the separation therein.

11. The system for supplying a carbon dioxide fluid according to claim 9, further comprising:
removing the partially vaporized pre-treated carbon dioxide stream from said heat exchange device and routing said partially vaporized pre-treated carbon dioxide stream across a pressure-reduction device, and conveying the resulting low pressure partially vaporized pre-treated carbon dioxide stream to said pre-treatment means.

12. The system for supplying a carbon dioxide fluid according to claim 8, further comprising:
conveying said first effluent stream across a pressure-reduction device to a waste separation device, wherein an enriched carbon dioxide stream is separated from a contaminant enriched stream.

13. The system for supplying a carbon dioxide fluid according to claim 12, further comprising:
splitting the carbon dioxide enriched stream exiting the waste separation device into two streams, wherein a first portion stream is routed over a pressure-reduction device, thereby reducing the pressure and temperature of said first stream, and a second portion is routed to said heat exchange device where it is at least partially condensed.

14. A system for supplying a refrigerant carbon dioxide fluid stream to a semiconductor application:
(a) supplying and routing a pre-treated carbon dioxide stream through a first heat exchange device to cool the carbon dioxide stream;
(b) routing the cooled carbon dioxide stream across a pressure-reduction device to generate a lower temperature and pressure stream;
(c) spraying said lower temperature and pressure stream into a second heat exchanger, where a second refrigerant stream is conveyed therethrough; and
(d) cooling said second refrigerant stream and conveying it to a semiconductor application requiring refrigeration.

15. The system for supplying a carbon dioxide fluid stream, according to claim 14, further comprising:
wherein the lower temperature and pressure stream exiting second heat exchanger in step (c) is returned to said first heat exchanger to continuously cool the pre-treated carbon dioxide stream supplied thereto.

16. The system for supplying a carbon dioxide fluid stream, according to claim 14, wherein said lower temperature and pressure stream of step (c) is either a vapor/liquid or a vapor/solid mixture.

17. An apparatus for supplying carbon dioxide fluid to two separate semiconductor applications, wherein one of said applications requires refrigeration, comprising:
(a) a pre-treatment means for pre-treating a fluid including a carbon dioxide component to form a treated carbon dioxide stream;
(b) a first semiconductor application, wherein a first portion of the treated carbon dioxide stream is routed via a first conduit and converted to a first effluent stream;
(c) a pressure-reduction device, capable of receiving and throttling a second portion of the treated carbon dioxide stream to form a lower pressure and temperature second stream; and
(d) a second semiconductor application, wherein the lower pressure and temperature second stream is routed via a second conduit to provide a cooling utility to said second semiconductor application where it is converted to a second effluent stream.

18. The apparatus for supplying a carbon dioxide fluid according to claim 17, further comprising:
a heat exchanger disposed upstream of said first. semiconductor application on said first conduit.

19. The apparatus for supplying a carbon dioxide fluid according to claim 17, further comprising:
a waste separation device disposed downstream of the first semiconductor application to receive said first effluent stream, and separate a carbon dioxide vapor enriched stream from a contaminant stream.

20. The apparatus for supplying a carbon dioxide fluid according to claim 17, further comprising:
a pressure-reduction device disposed downstream of the second semiconductor application accept said second effluent stream and generate a second low pressure stream and recycling it to said pre-treatment means.

21. The apparatus for supplying a carbon dioxide fluid according to claim 17, wherein the first semiconductor application is a cleaning application.

22. The apparatus for supplying a carbon dioxide fluid according to claim 17, wherein said second semiconductor application is selected from the group consisting of a plasma etch system, a thermal oxidation/annealing system, or a waste separation device.

23. The apparatus for supplying fluid according to claim 17, further comprising:
directing a third portion of said pre-treated carbon dioxide stream through a third conduit to a pressure-reduction device where the third carbon dioxide stream is converted to a lower pressure third carbon dioxide stream, and directing said lower pressure third carbon dioxide stream to a heat exchange device.

24. The apparatus for supplying fluid according to claim 23, further comprising:
a waste separation device disposed downstream of said first semiconductor application, wherein the first effluent is separated into a carbon dioxide enriched stream and a contaminant stream, said heat exchanger also being included in said waste separation device where a carbon dioxide liquid stream is generated and provided to a phase separation device within the waste separation device as a reflux to further aid in the separation.

25. The apparatus for supplying fluid according to claim 24, further comprising:
warming the enriched carbon dioxide enriched stream from said waste separation device in said heat exchange device, and recycling the same back to the pre-treatment means.

27. An apparatus for cooling and supplying a refrigerant carbon dioxide fluid to a semiconductor application, comprising:
a first heat exchange device in communication with a supply source to receive and cool a first purified carbon dioxide stream;
a pressure-reduction device disposed downstream from said first heat exchange device to generate a lower temperature and pressure purified carbon dioxide stream; and
a second heat exchange device disposed downstream from said pressure-reduction device to receive said lower temperature and pressure purified carbon dioxide stream and cool a second purified carbon dioxide stream via indirect heat exchange which is conveyed therethrough to the semiconductor application.

28. An apparatus for cooling and supplying a refrigerant carbon dioxide fluid according to claim 27, further comprising:
a conduit leading away from said second heat exchange device and in communication with said pre-treatment means to remove and recycle said purified carbon dioxide exiting the second heat exchange device.

29. The system for supplying a carbon dioxide fluid according to claim 3, wherein the carbon dioxide enriched stream exiting the waste separation device is routed to vent.

30. The system for supplying a carbon dioxide fluid according to claim 3, wherein the carbon dioxide enriched stream exiting the waste separation device is routed to the pre-treatment means.
